(19) United States
(12) Patent Application Publication
(10) Pub. No.: US 2022/0188605 A1
(43) Pub. Date: Jun. 16, 2022

(54) RECURRENT NEURAL NETWORK ARCHITECTURES BASED ON SYNAPTIC CONNECTIVITY GRAPHS

(71) Applicant: X Development LLC, Mountain View, CA (US)

(72) Inventors: Sarah Ann Laszlo, Mountain View, CA (US); Bangyan Chu, Fairfax, VA (US)

(21) Appl. No.: 17/119,288

(22) Filed: Dec. 11, 2020

(51) Int. Cl. G06N 3/06; G06N 3/04; G06N 3/08; G10L 17/18; G10L 17/04

(52) U.S. Cl. CPC G06N 3/061; G06N 3/0454; G10L 17/04; G10L 17/18; G06N 3/08

(57) ABSTRACT

Methods, systems, and apparatus, including computer programs encoded on a computer storage medium, for implementing a recurrent neural network that includes a brain emulation subnetwork. One of the methods includes obtaining an input sequence; and processing the input sequence using a recurrent neural network, wherein the recurrent neural network comprises a brain emulation subnetwork having a network architecture that has been determined according to a synaptic connectivity graph, the processing comprising: at a first time step, processing a first input element in the input sequence to generate a hidden state of the recurrent neural network; at each of a plurality of subsequent time steps, updating the hidden state of the recurrent neural network; and at each of one or more of the plurality of time steps, generating an output element for the time step based on the updated hidden state for the time step.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of computational units to generate an output for a received input. For example, a deep neural network is a deep machine learning model that includes an output layer and one or more hidden layers that each apply a non-linear transformation to a received input to generate an output.

### SUMMARY

This specification describes systems implemented as computer programs on one or more computers in one or more locations for implementing a recurrent neural network that includes a brain emulation neural network having a network architecture specified by a synaptic connectivity graph. This specification also describes systems for training a recurrent neural network that includes such a brain emulation neural network.

A synaptic connectivity graph refers to a graph representing the structure of synaptic connections between neurons in the brain of a biological organism, e.g., a fly. For example, the synaptic connectivity graph can be generated by processing a synaptic resolution image of the brain of a biological organism. For convenience, throughout this specification, a neural network having an architecture specified by a synaptic connectivity graph may be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that can be performed by the neural network or otherwise implicitly characterizing the neural network.

Particular embodiments of the subject matter described in this specification can be implemented so as to realize one or more of the following advantages.

The systems described in this specification can train and implement a recurrent neural network using a brain emulation neural network. Recurrent neural networks can process sequences of network inputs to generate network outputs more effectively and/or efficiently than other machine learning models. As described in this specification, brain emulation neural networks can achieve a higher performance (e.g., in terms of prediction accuracy), than other neural networks of an equivalent size (e.g., in terms of number of parameters). Put another way, brain emulation neural networks that have a relatively small size (e.g., 100 parameters) can achieve comparable performance with other neural networks that are much larger (e.g., thousands or millions of parameters). Therefore, using techniques described in this specification, a system can implement a highly efficient and low-latency recurrent neural network for processing sequences of network inputs. These efficiency gains can be especially important in low-resource or low-memory environments, e.g., on mobile devices or other edge devices. Additionally, these efficiency gains can be especially important in situations in which the recurrent neural network is continuously processing network inputs, e.g., in an application that continuously processes input audio data to determine whether a “wakeup” phrase has been spoken by a user.

The systems described in this specification can implement a brain emulation neural network having an architecture specified by a synaptic connectivity graph derived from a synaptic resolution image of the brain of a biological organism. The brains of biological organisms may be adapted by evolutionary pressures to be effective at solving certain tasks, e.g., classifying objects or generating robust object representations, and brain emulation neural networks can share this capacity to effectively solve tasks. In particular, compared to other neural networks, e.g., with manually specified neural network architectures, brain emulation neural networks can require less training data, fewer training iterations, or both, to effectively solve certain tasks. Moreover, brain emulation neural networks can perform certain machine learning tasks more effectively, e.g., with higher accuracy, than other neural networks.

The systems described in this specification can process a synaptic connectivity graph corresponding to a brain to select for neural populations with a particular function (e.g., sensor function, memory function, executive, and the like). In this specification, neurons that have the same function are referred to as being neurons with the same neuronal “type”. In particular, features can be computed for each node in the graph (e.g., the path length corresponding to the node and the number of edges connected to the node), and the node features can be used to classify certain nodes as corresponding to a particular type of function, i.e. to a particular type of neuron in the brain. A sub-graph of the overall graph corresponding to neurons that are predicted to be of a certain type can be identified, and a brain emulation neural network can be implemented with an architecture specified by the sub-graph, i.e., rather than the entire graph. Implementing a brain emulation neural network with an architecture specified by a sub-graph corresponding to neurons of a certain type can enable the brain emulation neural network to perform certain tasks more effectively while consuming fewer computational resources (e.g. memory and computing power). In one example, the brain emulation neural network can be configured to perform image processing tasks, and the architecture of the brain emulation neural network can be specified by a sub-graph corresponding to only the visual system of the brain (i.e., to visual system neurons). In another example, the brain emulation neural network can be configured to perform audio processing tasks, and the architecture of the brain emulation neural network can be specified by a sub-graph corresponding to only the audio system of the brain (i.e., to audio system neurons).

The systems described in this specification can use a brain emulation neural network in reservoir computing applications. In particular, a “reservoir computing” neural network can be implemented with an architecture specified by a brain emulation subnetwork and one or more trained subnetworks. During training of the reservoir computing neural network, only the weights of the trained subnetworks are trained, while the weights of the brain emulation neural network are (optionally) considered static and are (optionally) not trained. In some cases, a brain emulation neural network can have a very large number of parameters and a highly recurrent architecture; therefore training the parameters of the brain emulation neural network can be computationally-intensive and prone to failure, e.g., as a result of the model parameter values of the brain emulation neural network oscillating rather than converging to fixed values. The reservoir computing neural network described in this specification can harness the capacity of the brain emulation neural network, e.g., to generate representations that are effective for solving tasks, without requiring the brain emulation neural network to be trained.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of generating a brain emulation neural network based on a synaptic resolution image of the brain of a biological organism.

FIG. 2 illustrates an example recurrent computing system.

FIG. 3 illustrates an example recurrent neural network that includes a brain emulation subnetwork.

FIG. 4 shows an example data flow for generating a synaptic connectivity graph and a brain emulation neural network based on the brain of a biological organism.

FIG. 5 shows an example architecture mapping system.

FIG. 6 illustrates an example graph and an example sub-graph.

FIG. 7 is a flow diagram of an example process for implementing a recurrent neural network that includes a brain emulation subnetwork.

FIG. 8 is a flow diagram of an example process for generating a brain emulation neural network.

FIG. 9 is a flow diagram of an example process for determining an artificial neural network architecture corresponding to a sub-graph of a synaptic connectivity graph.

FIG. 10 is a block diagram of an example computer system.

Like reference numbers and designations in the various drawings indicate like elements.

### DETAILED DESCRIPTION

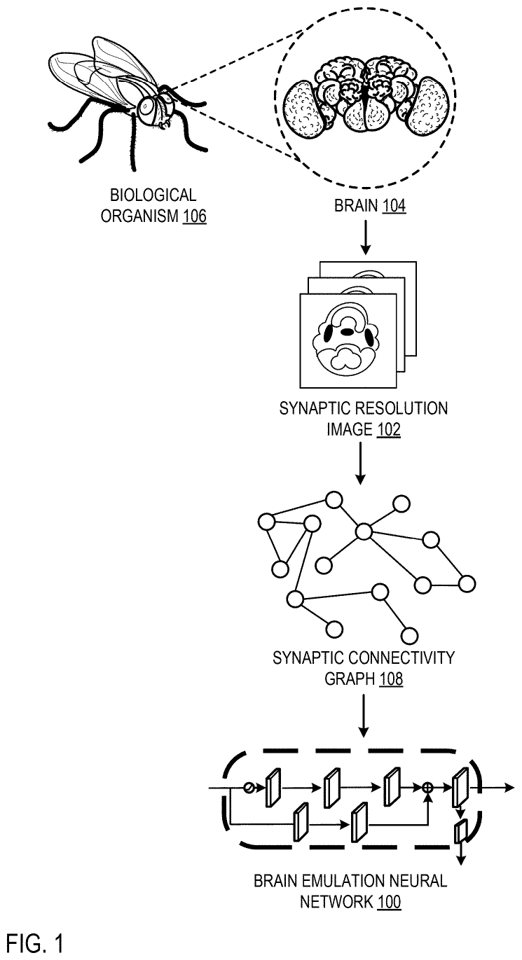

FIG. 1 illustrates an example of generating an artificial (i.e., computer implemented) brain emulation neural network 100 based on a synaptic resolution image 102 of the brain 104 of a biological organism 106, e.g., a fly. The synaptic resolution image 102 can be processed to generate a synaptic connectivity graph 108, e.g., where each node of the graph 108 corresponds to a neuron in the brain 104, and two nodes in the graph 108 are connected if the corresponding neurons in the brain 104 share a synaptic connection. The structure of the graph 108 can be used to specify the architecture of the brain emulation neural network 100. For example, each node of the graph 108 can mapped to an artificial neuron, a neural network layer, or a group of neural network layers in the brain emulation neural network 100. Further, each edge of the graph 108 can be mapped to a connection between artificial neurons, layers, or groups of layers in the brain emulation neural network 100. The brain 104 of the biological organism 106 can be adapted by evolutionary pressures to be effective at solving certain tasks, e.g., classifying objects or generating robust object representations, and the brain emulation neural network 100 can share this capacity to effectively solve tasks. These features and other features are described in more detail below.

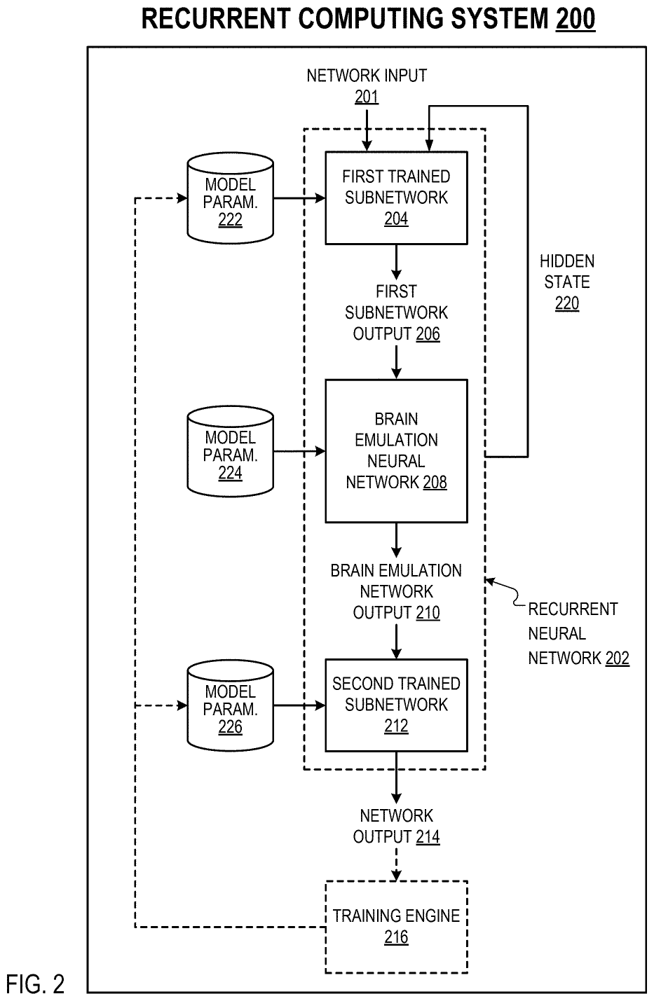

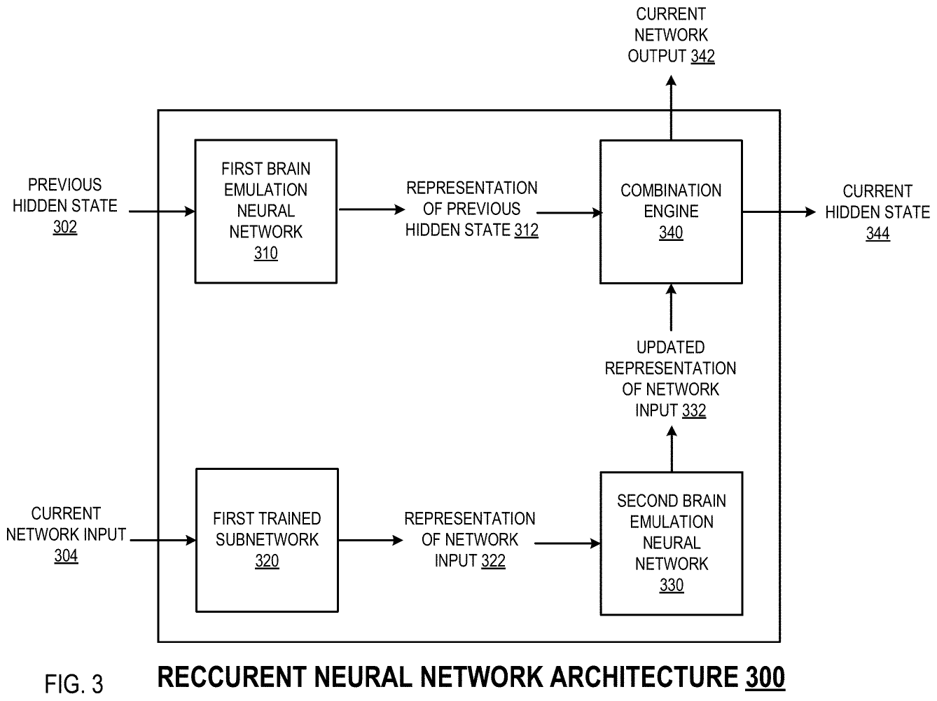

FIG. 2 and FIG. 3 show two examples of recurrent neural networks that include brain emulation neural networks.

A recurrent neural network is a neural network that is configured to process a sequence of network inputs to generate a (one or more) network output(s). In particular, a recurrent neural network can process each network input at respective time steps. For example, at each time step, a recurrent neural network can process i) the network input corresponding to the time step and ii) a current hidden state of the recurrent neural network to update the hidden state of the neural network. At each of one or more of the time steps, the recurrent neural network can generate an output element using the updated hidden state of the recurrent neural network.

The hidden state of a recurrent neural network can be an ordered collection of numeric values, e.g., a vector or matrix of floating point or other numeric values that has a fixed dimensionality. Similarly, the network input and network output of a neural network can each be an ordered collection of numeric values, e.g., a vector or matrix of floating point or other numeric values that has a fixed dimensionality.

A recurrent neural network can be a brain emulation neural network, or can include a subnetwork that is a brain emulation neural network. That is, a recurrent neural network, or a subnetwork of the recurrent neural network, can have a network architectures that has been determined using a graph representing synaptic connectivity between neurons in the brain of a biological organism.

FIG. 2 shows an example recurrent computing system 200. The recurrent computing system 200 is an example of a system implemented as computer programs on one or more computers in one or more locations in which the systems, components, and techniques described below are implemented.

The recurrent computing system 200 includes a recurrent neural network 202 that has (at least) three subnetworks: (i) a first trained subnetwork 204 (ii) a brain emulation neural network 208, and (iii) a second trained subnetwork 212. The recurrent neural network 202 is configured to process a network input 201 to generate a network output 214. The network input 201 includes a sequence of input elements.

More specifically, the first trained subnetwork 204 is configured to process, for each input element in the network input 201, the input element in accordance with a set of model parameters 222 of the first trained subnetwork 204 to generate a first subnetwork output 206. The brain emulation neural network 208 is configured to process the first subnetwork output 206 in accordance with a set of model parameters 224 of the brain emulation neural network 208 to generate a brain emulation network output 210. The second trained subnetwork 212 is configured to process the brain emulation network output 210 in accordance with a set of model parameters 226 of the second trained subnetwork 212 to generate an output element corresponding to the input element.

After each input element in the network input 201 has been processed by the recurrent neural network 202 to generate respective output elements, the recurrent neural network 202 can generate a network output 214 corresponding to the network input 201.

In some implementations, the network output 214 is the sequence of generated outputs elements. In some other implementations, the network output 214 is a subset of the generated output elements, e.g., the final output element corresponding to the final input element in the sequence of input elements of the network input 201. In some other implementations, the recurrent neural network 202 further processes the sequence of generated output elements to generate the network output 214. For example, the network output 214 can be the mean of the generated output elements.

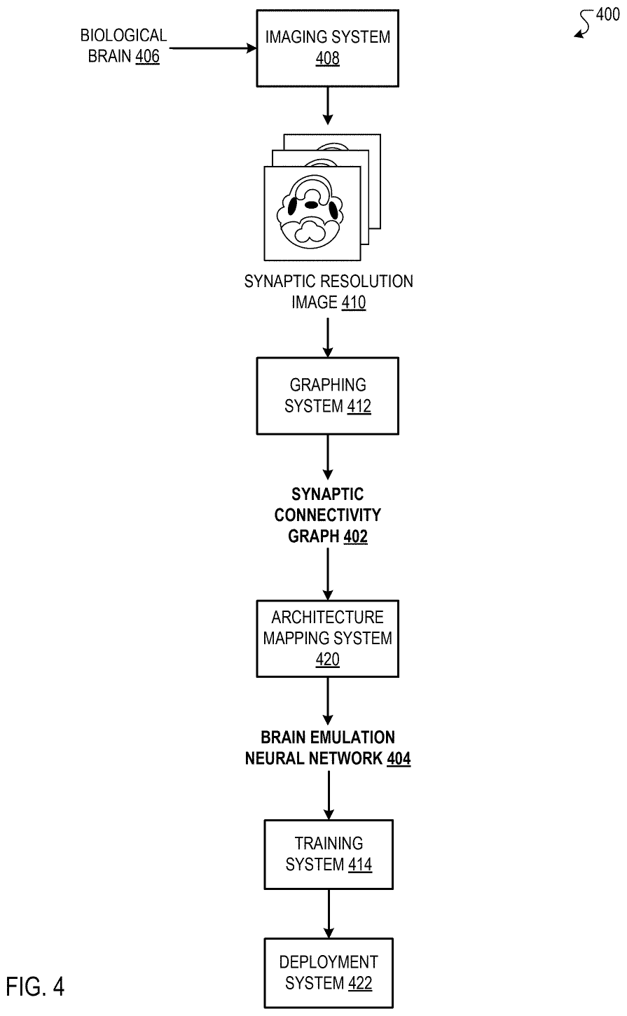

The brain emulation neural network 208 can have an architecture that is based on a graph representing synaptic connectivity between neurons in the brain of a biological organism. An example process for determining a network architecture using a synaptic connectivity graph is described below with respect to FIG. 4. The model parameters 224 can also be determined according to data characterizing the neurons in the brain of the biological organism; an example process for determining the model parameters of a brain emulation neural network is described below with respect to FIG. 4. In some implementations, the architecture of the brain emulation neural network 208 can be specified by the synaptic connectivity between neurons of a particular type in the brain, e.g., neurons from the visual system or the olfactory system, as described above.

In some implementations, the first trained subnetwork 204 and/or the second trained subnetwork 212 can include only one or a few neural network layers (e.g., a single fully-connected layer) that processes the respective subnetwork input to generate the respective subnetwork output. Although the recurrent neural network 202 depicted in FIG. 2 includes one trained subnetwork 204 before the brain emulation neural network 208 and one trained subnetwork 212 after the brain emulation neural network 208, in general the recurrent neural network 202 can include any number of trained subnetworks before and/or after the brain emulation neural network 208. For example, the recurrent neural network 202 can include zero, five, or ten trained subnetworks before the brain emulation neural network 208 and/or zero, five, or ten trained subnetworks after the brain emulation neural network 202. Generally there does not have to be the same number of trained subnetworks before and after the brain emulation neural network 202. In implementations where there are zero trained subnetworks before the brain emulation neural network 208, the brain emulation neural network can receive the network input 201 directly as input. In implementations where there are zero trained subnetworks after the brain emulation neural network 208, the brain emulation network output 210 can be the network output 214.

Although the recurrent neural network 202 depicted in FIG. 2 includes a single brain emulation neural network 208, in general the recurrent neural network 202 can include multiple brain emulation neural networks. In some implementations, each brain emulation neural network has the same set of model parameters 224; in some other implementations, each brain emulation neural network has a different set of model parameters 224. In some implementations, each brain emulation neural network has the same network architecture; in some other implementations, each brain emulation neural network has a different network architecture.

At each time step, the recurrent neural network 202 can output a hidden state 220. That is, at each time step, the recurrent neural network 202 updates its hidden state 220. Then, at the subsequent time step in the sequence of time steps, the recurrent neural network 202 receives as input (i) the input element of the network input 201 corresponding to the subsequent time step and (ii) the current hidden state 220.

In some implementations (e.g., in the example depicted in FIG. 2), the first trained subnetwork 204 receives both i) the input element of the network input 201 and ii) the hidden state 220. For example, the recurrent neural network 202 can combine the input element and the hidden state 220 (e.g., through concatenation, addition, multiplication, or an exponential function) to generate a combined input, and then process the combined input using the first trained subnetwork 204.

In some implementations, the brain emulation neural network 208 receives as input the hidden state 220 and the first subnetwork output 206. For example, the recurrent neural network 202 can combine the first subnetwork output 206 and the hidden state 220 (e.g., through concatenation, addition, multiplication, or an exponential function) to generate a combined input, and then process the combined input using the brain emulation neural network 208.

In some implementations, the second trained subnetwork 212 receives as input the hidden state 220 and the brain emulation network output 210. For example, the recurrent neural network 202 can combine the brain emulation network output 210 and the hidden state 220 (e.g., through concatenation, addition, multiplication, or an exponential function) to generate a combined input, and then process the combined input using the second trained subnetwork 212.

In some implementations, the updated hidden state 220 generated at a time step is the same as the output element generated at the time step. In some other implementations, the hidden state 220 is an intermediate output of the recurrent neural network 202. An intermediate output refers to an output generated by a hidden artificial neuron or a hidden neural network layer of the recurrent neural network 202, i.e., an artificial neuron or neural network layer that is not included in the input layer or the output layer of the recurrent neural network 202. For example, the hidden state 220 can be the output of the brain emulation network output 210. In some other implementations, the hidden state 220 is a combination of the output element and one or more intermediate outputs of the recurrent neural network 202. For example, the hidden state 220 can be computed using the output element and the brain emulation network output 210, e.g., by combining the two outputs and applying an activation function.

In some implementations, the brain emulation neural network 208 itself has a recurrent neural network architecture. That is, during each time step of the recurrent neural network 202, the brain emulation neural network can process the first subnetwork output 206 multiple times at respective sub-time steps. For example, the architecture of the brain emulation neural network 208 can include a sequence of components (e.g., artificial neurons, neural network layers, or groups of neural network layers) such that the architecture includes a connection from each component in the sequence to the next component, and the first and last components of the sequence are identical. In one example, two artificial neurons that are each directly connected to one another (i.e., where the first neuron provides its output the second neuron, and the second neuron provides its output to the first neuron) would form a recurrent loop. A recurrent brain emulation neural network can process a network input over multiple sub-time steps to generate a respective brain emulation network output 210 of the network input at each sub-time step. In particular, at each sub-time step, the brain emulation neural network can process: (i) the network input, and (ii) any outputs generated by the brain emulation neural network 208 at the preceding sub-time step, to generate the brain emulation network output 210 for the sub-time step. The recurrent neural network 202 can provide the brain emulation network output 210 generated by the brain emulation neural network 208 at the final sub-time step as the input to the second trained subnetwork 212. The number of sub-time steps over which the brain emulation neural network 208 processes a network input can be a predetermined hyper-parameter of the recurrent computing system 200.

In some implementations, in addition to processing the brain emulation network output 210 generated by the output layer of the brain emulation neural network 208, the second trained subnetwork 212 can additionally process one or more intermediate outputs of the brain emulation neural network 208.

The recurrent computing system 200 includes a training engine 216 that is configured to train the recurrent neural network 202.

In some implementations, the recurrent neural network 202 is a reservoir computing neural network; that is, the recurrent neural network 202 can include one or more untrained subnetworks. In particular, the brain emulation neural network 208 can be untrained; that is, the parameter values of the brain emulation neural network 208 are not determined by a training system using training examples, but rather using a synaptic connectivity graph; this process is described in more detail below. A reservoir computing neural network with a recurrent neural network architecture is sometimes called an “echo state network.”

Training the recurrent neural network 202 from end-to-end (i.e., training the model parameters 222 of the first trained subnetwork 204, the model parameters 224 of the brain emulation neural network 208, and the model parameters 226 of the second trained subnetwork 212) can be difficult due to the complexity of the architecture of the brain emulation neural network 208. Therefore, training the recurrent neural network 202 from end-to-end using machine learning training techniques can be computationally-intensive and the training can fail to converge, e.g., if the values of the model parameters of the recurrent neural network 202 oscillate rather than converge to fixed values. Even in cases where the training of the recurrent neural network 202 converges, the performance of the recurrent neural network 202 (e.g., measured by prediction accuracy) can fail to achieve an acceptable threshold. For example, the large number of model parameters of the recurrent neural network 202 can overfit a limited amount of training data.

Rather than training the entire recurrent neural network 202 from end-to-end, the training engine 216 can train only the model parameters 222 of the first trained subnetwork 204 and the model parameters 226 of the second trained subnetwork 212, while (optionally) leaving the model parameters 224 of the brain emulation neural network 208 fixed during training. The model parameters 224 of the brain emulation neural network 208 can be determined before the training of the second trained subnetwork 212 based on the weight values of the edges in the synaptic connectivity graph. Optionally, the weight values of the edges in the synaptic connectivity graph can be transformed (e.g., by additive random noise) prior to being used for specifying model parameters 224 of the brain emulation neural network 208. This training procedure enables the recurrent neural network 202 to take advantage of the highly complex and non-linear behavior of the brain emulation neural network 208 in performing prediction tasks while obviating the challenges of training the brain emulation neural network 208.

The training engine 216 can train the recurrent neural network 202 on a set of training data over multiple training iterations. The training data can include a set of training examples, where each training example specifies: (i) a training network input that includes a sequence of input elements, and (ii) a target network output that should be generated by the recurrent neural network 202 by processing the training network input.

At each training iteration, the training engine 216 can sample a batch of training examples from the training data, and process the training inputs specified by the training examples using the recurrent neural network 202 to generate corresponding network outputs 214. In particular, for each training input, the recurrent neural network 202 processes each input element in the training input using the current model parameter values 222 of the first trained subnetwork 204 to generate a respective first subnetwork output 206. The recurrent neural network 202 processes the first subnetwork output 206 in accordance with the static model parameter values 224 of the brain emulation neural network 208 to generate a brain emulation network output 210. The recurrent neural network 202 then processes the brain emulation network output 210 using the current model parameter values 226 of the second trained subnetwork 212 to generate the respective output elements corresponding to the input elements of the training input. After each input element has been processed, the recurrent neural network 202 can determine a network output 214 as described above.

The training engine 216 adjusts the model parameters values 222 of the first trained subnetwork 204 and the model parameter values 226 of the second trained subnetwork 212 to optimize an objective function that measures a similarity between: (i) the network outputs 214 generated by the recurrent neural network 202, and (ii) the target network outputs specified by the training examples. The objective function can be, e.g., a cross-entropy objective function, a squared-error objective function, or any other appropriate objective function.

To optimize the objective function, the training engine 216 can determine gradients of the objective function with respect to the model parameters 222 of the first trained subnetwork 204 and the model parameters 226 of the second trained subnetwork 212, e.g., using backpropagation techniques. The training engine 216 can then use the gradients to adjust the model parameter values 226 of the prediction neural network, e.g., using any appropriate gradient descent optimization technique, e.g.., an RMSprop or Adam gradient descent optimization technique.

The training engine 216 can use any of a variety of regularization techniques during training of the recurrent neural network 202. For example, the training engine 216 can use a dropout regularization technique, such that certain artificial neurons of the brain emulation neural network are “dropped out” (e.g., by having their output set to zero) with a non-zero probability p>0 each time the brain emulation neural network processes a network input. Using the dropout regularization technique can improve the performance of the trained recurrent neural network 202, e.g., by reducing the likelihood of over-fitting. As another example, the training engine 216 can regularize the training of the recurrent neural network 202 by including a “penalty” term in the objective function that measures the magnitude of the model parameter values 226 of the second trained subnetwork 212. The penalty term can be, e.g., an L₁ or L₂ norm of the model parameter values 222 of the first trained subnetwork 204 and/or the model parameter values 226 of the second trained subnetwork 212.

In some cases, the values of the intermediate outputs of the brain emulation neural network 208 can have large magnitudes, e.g., as a result from the parameter values of the brain emulation neural network 208 being derived from the weight values of the edges of the synaptic connectivity graph rather than being trained. Therefore, to facilitate training of the recurrent neural network 202, batch normalization layers can be included between the layers of the brain emulation neural network 208, which can contribute to limiting the magnitudes of intermediate outputs generated by the brain emulation neural network. Alternatively or in combination, the activation functions of the neurons of the brain emulation neural network can be selected to have a limited range. For example, the activation functions of the neurons of the brain emulation neural network can be selected to be sigmoid activation functions with range given by [0,1].

The recurrent neural network 202 can be configured to perform any appropriate task. A few examples follow, referring to the implementations in which the recurrent neural network 202 has a recurrent network architecture.

In one example, the recurrent neural network 202 can be configured to process network inputs 201 that represent sequences of audio data. For example, each input element in the network input 201 can be a raw audio sample or an input generated from a raw audio sample (e.g., a spectrogram), and the recurrent neural network 202 can process the sequence of input elements to generate network outputs 214 representing predicted text samples that correspond to the audio samples. That is, the recurrent neural network 202 can be a “speech-to-text” neural network. As another example, each input element can be a raw audio sample or an input generated from a raw audio sample, and the recurrent neural network 202 can generate a predicted class of the audio samples, e.g., a predicted identification of a speaker corresponding to the audio samples. As a particular example, the predicted class of the audio sample can represent a prediction of whether the input audio example is a verbalization of a predefined work or phrase, e.g., a “wakeup” phrase of a mobile device. In some implementations, the brain emulation neural network 208 can be generated from a subgraph of the synaptic connectivity graph corresponding to an audio region of the brain, i.e., a region of the brain that processes auditory information (e.g., the auditory cortex).

In another example, the recurrent neural network 202 can be configured to process network inputs 201 that represent sequences of text data. For example, each input element in the network input 201 can be a text sample (e.g., a character, phoneme, or word) or an embedding of a text sample, and the recurrent neural network 202 can process the sequence of input elements to generate network outputs 214 representing predicted audio samples that correspond to the text samples. That is, the recurrent neural network 202 can be a “text-to-speech” neural network. As another example, each input element can be an input text sample or an embedding of an input text sample, and the recurrent neural network can generate a network output 214 representing a sequence of output text samples corresponding to the sequences of input text samples. As a particular example, the output text samples can represent the same text as the input text samples in a different language (i.e., the recurrent neural network 202 can be a machine translation neural network). As another particular example, the output text samples can represent an answer to a question posed by the input text samples (i.e., the recurrent neural network 202 can be a question-answering neural network). As another example, the input text samples can represent two texts (e.g., as separated by a delimiter token), and the recurrent neural network 202 can generate a network output representing a predicted similarity between the two texts. In some implementations, the brain emulation neural network 208 can be generated from a subgraph of the synaptic connectivity graph corresponding to a speech region of the brain, i.e., a region of the brain that is linked to speech production (e.g., Broca's area).

In another example, the recurrent neural network 202 can be configured to process network inputs 201 representing sequences of images, e.g., sequences of video frames. For example, each input element in the network input 201 can be a video frame or an embedding of a video frame, and the recurrent neural network 202 can process the sequence of input elements to generate a network output 214 representing a prediction about the video represented by the sequence of video frames. As a particular example, the recurrent neural network 202 can be configured to track a particular object in each of the frames of the video, i.e., to generate a network output 214 that includes a sequences of output elements, where each output elements represents a predicted location within a respective video frames of the particular object. In some implementations, the brain emulation neural network 208 can be generated from a subgraph of the synaptic connectivity graph corresponding to a visual region of the brain, i.e., a region of the brain that processes visual information (e.g., the visual cortex).

In another example, the recurrent neural network 202 can be configured to process a network input 201 representing a respective current state of an environment at each of a sequence of time steps, and to generate a network output 214 representing a sequence of selection outputs that can be used to select actions to be performed by an agent interacting with the environment. For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

In this specification, an embedding is an ordered collection of numeric values that represents an input in a particular embedding space. For example, an embedding can be a vector of floating point or other numeric values that has a fixed dimensionality.

After training, the recurrent neural network 202 can be directly applied to perform prediction tasks. For example, the recurrent neural network 202 can be deployed onto a user device. In some implementations, the recurrent neural network 202 can be deployed directly into resource-constrained environments (e.g., mobile devices). Recurrent neural networks 202 that includes brain emulation neural networks 208 can generally perform at a high level, e.g., in terms of prediction accuracy, even with very few model parameters compared to other neural networks. For example, recurrent neural networks 202 as described in this specification that have, e.g., 100 or 1000 model parameters can achieve comparable performance to other neural networks that have millions of model parameters. Thus, the recurrent neural network 202 can be implemented efficiently and with low latency on user devices.

In some implementations, after the recurrent neural network 202 has been deployed onto a user device, some or all of the parameters of the recurrent neural network 202 can be further trained, i.e., “fine-tuned,” using new training example obtained by the user device. For example, some or all of the parameters can be fine-tuned using training example corresponding to the specific user of the user device, so that the reservoir neural network 202 can achieve a higher accuracy for inputs provided by the specific user. As a particular example, the model parameters 222 of the first trained subnetwork 204 and/or the model parameters 226 of the second trained subnetwork 212 can be fine-tuned on the user device using new training exampled while the model parameters 224 of the brain emulation neural network 208 are held static, as described above.

FIG. 3 illustrates an example recurrent neural network 300 that includes brain emulation subnetworks 310 and 330. The recurrent neural network 300 is an example of a system implemented as computer programs on one or more computers in one or more locations in which the systems, components, and techniques described below are implemented.

The recurrent neural network 300 has three subnetworks: (i) a first brain emulation neural network 310 (ii) a second brain emulation neural network 330, and (iii) a trained subnetwork 320. In some implementations, the parameters of the brain emulation neural networks 310 and 330 are not trained, as described above with respect to FIG. 2.

The recurrent neural network 300 is configured to process, at each time step in a sequence of multiple time steps, (i) a previous hidden state 302 generated at the previous time step in the sequence of time step and (ii) a current network input 304 corresponding to the current time step, and to generate (i) a current network output 342 corresponding to the current time step and (ii) an updated hidden sate 344 corresponding to the current time step.

More specifically, the first brain emulation neural network 310 is configured to receive the previous hidden state 302 and to process the previous hidden state 302 to generate a representation 312 of the previous hidden state. The trained subnetwork 320 is configured to receive the current network input 304 and to process the current network input 304 to generate a representation 322 of the current network input. The second brain emulation neural network 330 is configured to receive the representation 322 of the current network input and to process the representation 322 of the current network input to generate an updated representation 332 of the current network input.

The brain emulation neural networks 310 and 330 can each have an architecture that is based on a graph representing synaptic connectivity between neurons in the brain of a biological organism. For example, the brain emulation neural networks 310 and 330 can have been determined according to the process described below with respect to FIG. 4. In some cases, the architecture of the brain emulation neural networks 310 and 330 can be specified by the synaptic connectivity between neurons of a particular type in the brain, e.g., neurons from the visual system or the olfactory system, as described above. In some implementations, the brain emulation neural networks 310 and 330 have the same network architecture and same parameter values. In some other implementations, the brain emulation neural networks 310 and 330 have different parameter values and/or different architectures.

In some implementations, the trained subnetwork 320 includes only one or a few neural network layers (e.g., a single fully-connected layer).

The recurrent neural network 300 also includes a combination engine 340 that is configured to combine (i) the representation 312 of the previous hidden state and (ii) the updated representation 332 of the current network input, generating (i) the current network output 342 and (ii) the updated hidden state 344.

In some implementations, the combination engine 340 combines the representation 312 of the previous hidden state and the updated representation 332 of the current network input using a second trained subnetwork. In some other implementations, the combination engine adds, multiplies, or concatenates the representation 312 and the updated representation 332 to generate an initial combined representation, and then processes the initial combined representation using an activation function (e.g., a Tanh function, a RELU function, or a Leaky RELU function) to generate the current network output 342 and the updated hidden state 344.

In some implementations, the current network output 342 and the updated hidden state 344 are the same. In some other implementations, the current network output 342 and the updated hidden state 344 are different. For example, the combination engine 340 can generate the current network output 342 and the updated hidden state 344 using respective different trained subnetworks.

As a particular example, each network input 304 can represent audio data, and each network output 342 can represent a prediction about the audio data represented by the corresponding network input 304, e.g., a prediction of a text sample (e.g., a grapheme, phoneme, character, word fragment, or word) represented by the audio data. In this example, the network input 304 can be any data that represents audio. For example, the network input 304 can include one or more of: a one-dimensional raw audio sample, a raw spectrogram generated from the audio sample, a Mel spectrogram generated from the audio sample, or a mel-frequency cepstral coefficient (MFCC) representation of the audio sample.

In some implementations, each network input 304 represents a current audio sample and one or more previous audio samples corresponding to respective previous time steps. For example, the network input 304 can be a spectrogram, e.g., a Mel spectrogram, that represents the current time step and the one or more previous time steps. Thus, the sequence of network inputs 304 can represent a sliding window of multiple time steps of audio data.

In some implementations, the output of the recurrent neural network 300 is the sequence of generated network outputs 342. In some other implementations, the output of the recurrent neural network 300 is a subset of the generated network outputs, e.g., the final generated network output 342 corresponding to the final time step. In some other implementations, the sequence of generated network outputs 342 is further processed to generate a final output. For example, the output of the recurrent neural network 300 can be the mean of the generated network outputs 342.

As a particular example, the final output of the recurrent neural network can be a prediction of whether a particular word or phrase was represented by the sequence of network inputs 304, e.g, a “wakeup” phrase of a mobile device that causes the mobile device to turn on in response to a verbal prompt from the user.

FIG. 4 shows an example data flow 400 for generating a synaptic connectivity graph 402 and a brain emulation neural network 404 based on the brain 406 of a biological organism. As used throughout this document, a brain may refer to any amount of nervous tissue from a nervous system of a biological organism, and nervous tissue may refer to any tissue that includes neurons (i.e., nerve cells). The biological organism can be, e.g., a worm, a fly, a mouse, a cat, or a human.

An imaging system 408 can be used to generate a synaptic resolution image 410 of the brain 406. An image of the brain 406 may be referred to as having synaptic resolution if it has a spatial resolution that is sufficiently high to enable the identification of at least some synapses in the brain 406. Put another way, an image of the brain 406 may be referred to as having synaptic resolution if it depicts the brain 406 at a magnification level that is sufficiently high to enable the identification of at least some synapses in the brain 406. The image 410 can be a volumetric image, i.e., that characterizes a three-dimensional representation of the brain 406. The image 410 can be represented in any appropriate format, e.g., as a three-dimensional array of numerical values.

The imaging system 408 can be any appropriate system capable of generating synaptic resolution images, e.g., an electron microscopy system. The imaging system 408 can process “thin sections” from the brain 406 (i.e., thin slices of the brain attached to slides) to generate output images that each have a field of view corresponding to a proper subset of a thin section. The imaging system 408 can generate a complete image of each thin section by stitching together the images corresponding to different fields of view of the thin section using any appropriate image stitching technique. The imaging system 408 can generate the volumetric image 410 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 412 is configured to process the synaptic resolution image 410 to generate the synaptic connectivity graph 402. The synaptic connectivity graph 402 specifies a set of nodes and a set of edges, such that each edge connects two nodes. To generate the graph 402, the graphing system 412 identifies each neuron in the image 410 as a respective node in the graph, and identifies each synaptic connection between a pair of neurons in the image 410 as an edge between the corresponding pair of nodes in the graph.

The graphing system 412 can identify the neurons and the synapses depicted in the image 410 using any of a variety of techniques. For example, the graphing system 412 can process the image 410 to identify the positions of the neurons depicted in the image 410, and determine whether a synapse connects two neurons based on the proximity of the neurons (as will be described in more detail below). In this example, the graphing system 412 can process an input including: (i) the image, (ii) features derived from the image, or (iii) both, using a machine learning model that is trained using supervised learning techniques to identify neurons in images. The machine learning model can be, e.g., a convolutional neural network model or a random forest model. The output of the machine learning model can include a neuron probability map that specifies a respective probability that each voxel in the image is included in a neuron. The graphing system 412 can identify contiguous clusters of voxels in the neuron probability map as being neurons.

Optionally, prior to identifying the neurons from the neuron probability map, the graphing system 412 can apply one or more filtering operations to the neuron probability map, e.g., with a Gaussian filtering kernel. Filtering the neuron probability map can reduce the amount of “noise” in the neuron probability map, e.g., where only a single voxel in a region is associated with a high likelihood of being a neuron.

The machine learning model used by the graphing system 412 to generate the neuron probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 410 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi: 10.1101/605634 (2019).

The graphing system 412 can identify the synapses connecting the neurons in the image 410 based on the proximity of the neurons. For example, the graphing system 412 can determine that a first neuron is connected by a synapse to a second neuron based on the area of overlap between: (i) a tolerance region in the image around the first neuron, and (ii) a tolerance region in the image around the second neuron. That is, the graphing system 412 can determine whether the first neuron and the second neuron are connected based on the number of spatial locations (e.g., voxels) that are included in both: (i) the tolerance region around the first neuron, and (ii) the tolerance region around the second neuron. For example, the graphing system 412 can determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron can be specified as the set of spatial locations in the image that are either: (i) in the interior of the neuron, or (ii) within a predefined distance of the interior of the neuron.

The graphing system 412 can further identify a weight value associated with each edge in the graph 402. For example, the graphing system 412 can identify a weight for an edge connecting two nodes in the graph 402 based on the area of overlap between the tolerance regions around the respective neurons corresponding to the nodes in the image 410. The area of overlap can be measured, e.g., as the number of voxels in the image 410 that are contained in the overlap of the respective tolerance regions around the neurons. The weight for an edge connecting two nodes in the graph 402 may be understood as characterizing the (approximate) strength of the connection between the corresponding neurons in the brain (e.g., the amount of information flow through the synapse connecting the two neurons).

In addition to identifying synapses in the image 410, the graphing system 412 can further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi: 10.1038/s41467-019-12201-w.

In implementations where the graphing system 412 determines the directions of the synapses in the image 410, the graphing system 412 can associate each edge in the graph 402 with the direction of the corresponding synapse. That is, the graph 402 can be a directed graph. In some other implementations, the graph 402 can be an undirected graph, i.e., where the edges in the graph are not associated with a direction.

The graph 402 can be represented in any of a variety of ways. For example, the graph 402 can be represented as a two-dimensional array of numerical values with a number of rows and columns equal to the number of nodes in the graph. The component of the array at position (i,j) can have value 1 if the graph includes an edge pointing from node i to node j, and value 0 otherwise. In implementations where the graphing system 412 determines a weight value for each edge in the graph 402, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

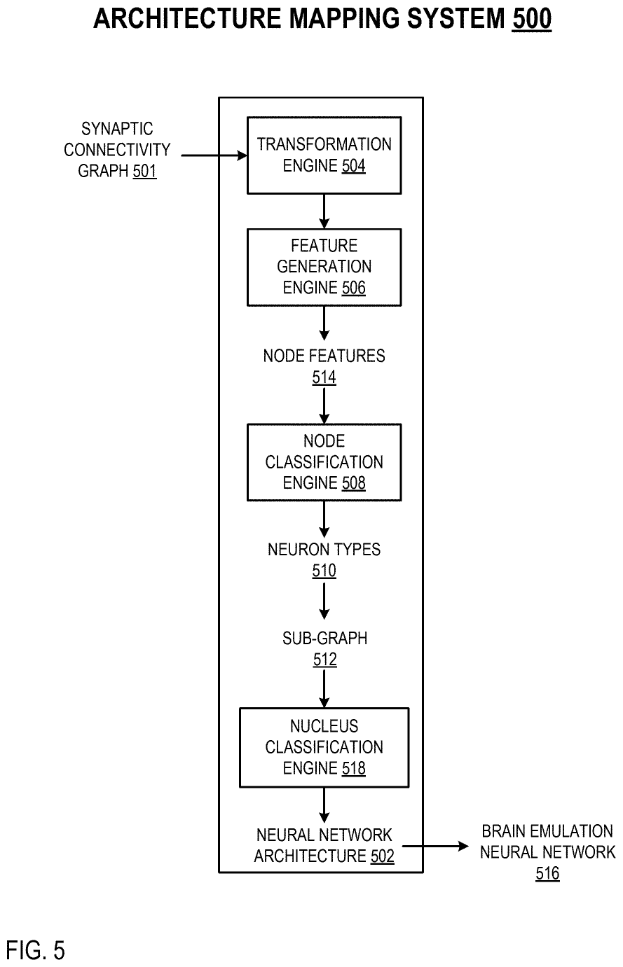

An architecture mapping system 420 can process the synaptic connectivity graph 402 to determine the architecture of the brain emulation neural network 404. For example, the architecture mapping system 420 can map each node in the graph 402 to: (i) an artificial neuron, (ii) a neural network layer, or (iii) a group of neural network layers, in the architecture of the brain emulation neural network 404. The architecture mapping system 420 can further map each edge of the graph 402 to a connection in the brain emulation neural network 404, e.g., such that a first artificial neuron that is connected to a second artificial neuron is configured to provide its output to the second artificial neuron. In some implementations, the architecture mapping system 420 can apply one or more transformation operations to the graph 402 before mapping the nodes and edges of the graph 402 to corresponding components in the architecture of the brain emulation neural network 404, as will be described in more detail below. An example architecture mapping system is described in more detail below with reference to FIG. 5.

The brain emulation neural network 404 can be provided to a training system 414 that trains the brain emulation neural network using machine learning techniques, i.e., generates an update to the respective values of one or more parameters of the brain emulation neural network.

In some implementations, the training system 414 is a supervised training system that is configured to train the brain emulation neural network 404 using a set of training data. The training data can include multiple training examples, where each training example specifies: (i) a training input, and (ii) a corresponding target output that should be generated by the brain emulation neural network 404 by processing the training input. In one example, the direct training system 414 can train the brain emulation neural network 404 over multiple training iterations using a gradient descent optimization technique, e.g., stochastic gradient descent. In this example, at each training iteration, the direct training system 414 can sample a “batch” (set) of one or more training examples from the training data, and process the training inputs specified by the training examples to generate corresponding network outputs. The direct training system 414 can evaluate an objective function that measures a similarity between: (i) the target outputs specified by the training examples, and (ii) the network outputs generated by the brain emulation neural network, e.g., a cross-entropy or squared-error objective function. The direct training system 414 can determine gradients of the objective function, e.g., using backpropagation techniques, and update the parameter values of the brain emulation neural network 404 using the gradients, e.g., using any appropriate gradient descent optimization algorithm, e.g., RMSprop or Adam.

In some other implementations, the training system 414 is an adversarial training system that is configured to train the brain emulation neural network 404 in an adversarial fashion. For example, the training system 414 can include a discriminator neural network that is configured to process network outputs generated by the brain emulation neural network 404 to generate a prediction of whether the network outputs are “real” outputs (i.e., outputs that were not generated by the brain emulation neural network, e.g., outputs that represent data that was captured from the real world) or “synthetic” outputs (i.e., outputs generated by the brain emulation neural network 404). The training system can then determine an update to the parameters of the brain emulation neural network in order to increase an error in the prediction of the discriminator neural network; that is, the goal of the brain emulation neural network is to generate synthetic outputs that are realistic enough that the discriminator neural network predicts them to be real outputs. In some implementations, concurrently with training the brain emulation neural network 404, the training system 414 generates updates to the parameters of the discriminator neural network.

In some other implementations, the training system 414 is a distillation training system that is configured to use the brain emulation neural network 404 to facilitate training of a “student” neural network having a less complex architecture than the brain emulation neural network 404. The complexity of a neural network architecture can be measured, e.g., by the number of parameters required to specify the operations performed by the neural network. The training system 414 can train the student neural network to match the outputs generated by the brain emulation neural network. After training, the student neural network can inherit the capacity of the brain emulation neural network 404 to effectively solve certain tasks, while consuming fewer computational resources (e.g., memory and computing power) than the brain emulation neural network 404. Typically, the training system 414 does not update the parameters of the brain emulation neural network 404 while training the student neural network. That is, in these implementations, the training system 414 is configured to train the student neural network instead of the brain emulation neural network 404.

As a particular example, the training system 414 can be a distillation training system that trains the student neural network in an adversarial manner. For example, the training system 414 can include a discriminator neural network that is configured to process network outputs that were generated either by the brain emulation neural network 404 or the student neural network, and to generate a prediction of whether the network outputs where generated by the brain emulation neural network 404 or the student neural network. The training system can then determine an update to the parameters of the student neural network in order to increase an error in the prediction of the discriminator neural network; that is, the goal of the student neural network is to generate network outputs that resemble network outputs generated by the brain emulation neural network 402 so that the discriminator neural network predicts that they were generated by the brain emulation neural network 404.

In some implementations, the brain emulation neural network 404 is a subnetwork of a neural network that includes one or more other neural network layers, e.g., one or more other subnetworks.

For example, the brain emulation neural network 404 can be a subnetwork of a “reservoir computing” neural network. The reservoir computing neural network can include i) the brain emulation neural network, which includes untrained parameters, and ii) one or more other subnetworks that include trained parameters. For example, the reservoir computing neural network can be configured to process a network input using the brain emulation neural network 404 to generate an alternative representation of the network input, and process the alternative representation of the network input using a “prediction” subnetwork to generate a network output.

During training of the reservoir computing neural network, the parameter values of the one or more other subnetworks (e.g., the prediction subnetwork) are trained, but the parameter values of the brain emulation neural network 404 are static, i.e., are not trained. Instead of being trained, the parameter values of the brain emulation neural network 404 can be determined from the weight values of the edges of the synaptic connectivity graph, as will be described in more detail below. The reservoir computing neural network facilitates application of the brain emulation neural network to machine learning tasks by obviating the need to train the parameter values of the brain emulation neural network 404.

After the training system 414 has completed training the brain emulation neural network 404 (or a neural network that includes the brain emulation neural network as a subnetwork, or a student neural network trained using the brain emulation neural network), the brain emulation neural network 404 can be deployed by a deployment system 422. That is, the operations of the brain emulation neural network 404 can be implemented on a device or a system of devices for performing inference, i.e., receiving network inputs and processing the network inputs to generate network outputs. In some implementations, the brain emulation neural network 404 can be deployed onto a cloud system, i.e., a distributed computing system having multiple computing nodes, e.g., hundreds or thousands of computing nodes, in one or more locations. In some other implementations, the brain emulation neural network 404 can be deployed onto a user device.

For example, the brain emulation neural network 404 (or a neural network that includes the brain emulation neural network as a subnetwork, or a student neural network that has been trained using the brain emulation neural network) can be deployed as a recurrent neural network that is configured to process a sequence of network inputs, as described above.

FIG. 5 shows an example architecture mapping system 500. The architecture mapping system 500 is an example of a system implemented as computer programs on one or more computers in one or more locations in which the systems, components, and techniques described below are implemented.

The architecture mapping system 500 is configured to process a synaptic connectivity graph 501 (e.g., the synaptic connectivity graph 402 depicted in FIG. 4) to determine a corresponding neural network architecture 502 of a brain emulation neural network 516 (e.g., the brain emulation neural network 404 depicted in FIG. 4). The architecture mapping system 500 can determine the architecture 502 using one or more of: a transformation engine 504, a feature generation engine 506, a node classification engine 508, and a nucleus classification engine 518, which will each be described in more detail next.

The transformation engine 504 can be configured to apply one or more transformation operations to the synaptic connectivity graph 501 that alter the connectivity of the graph 501, i.e., by adding or removing edges from the graph. A few examples of transformation operations follow.

In one example, to apply a transformation operation to the graph 501, the transformation engine 504 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 504 can modify the connectivity between the two nodes in the node pair with a predefined probability (e.g., 0.1%). In one example, the transformation engine 504 can connect the nodes by an edge (i.e., if they are not already connected by an edge) with the predefined probability. In another example, the transformation engine 504 can reverse the direction of any edge connecting the two nodes with the predefined probability. In another example, the transformation engine 504 can invert the connectivity between the two nodes with the predefined probability, i.e., by adding an edge between the nodes if they are not already connected, and by removing the edge between the nodes if they are already connected.

In another example, the transformation engine 504 can apply a convolutional filter to a representation of the graph 501 as a two-dimensional array of numerical values. As described above, the graph 501 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 504 can quantize the values in the array representing the graph, e.g., by rounding each value in the array to 0 or 1, to cause the array to unambiguously specify the connectivity of the graph. Applying a convolutional filter to the representation of the graph 501 can have the effect of regularizing the graph, e.g., by smoothing the values in the array representing the graph to reduce the likelihood of a component in the array having a different value than many of its neighbors.

In some cases, the graph 501 can include some inaccuracies in representing the synaptic connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the synaptic connectivity in the brain, e.g., by removing spurious edges.

The architecture mapping system 500 can use the feature generation engine 506 and the node classification engine 508 to determine predicted “types” 510 of the neurons corresponding to the nodes in the graph 501. The type of a neuron can characterize any appropriate aspect of the neuron. In one example, the type of a neuron can characterize the function performed by the neuron in the brain, e.g., a visual function by processing visual data, an olfactory function by processing odor data, or a memory function by retaining information. After identifying the types of the neurons corresponding to the nodes in the graph 501, the architecture mapping system 500 can identify a sub-graph 512 of the overall graph 501 based on the neuron types, and determine the neural network architecture 502 based on the sub-graph 512. The feature generation engine 506 and the node classification engine 508 are described in more detail next.

The feature generation engine 506 can be configured to process the graph 501 (potentially after it has been modified by the transformation engine 504) to generate one or more respective node features 514 corresponding to each node of the graph 501. The node features corresponding to a node can characterize the topology (i.e., connectivity) of the graph relative to the node. In one example, the feature generation engine 506 can generate a node degree feature for each node in the graph 501, where the node degree feature for a given node specifies the number of other nodes that are connected to the given node by an edge. In another example, the feature generation engine 506 can generate a path length feature for each node in the graph 501, where the path length feature for a node specifies the length of the longest path in the graph starting from the node. A path in the graph may refer to a sequence of nodes in the graph, such that each node in the path is connected by an edge to the next node in the path. The length of a path in the graph may refer to the number of nodes in the path. In another example, the feature generation engine 506 can generate a neighborhood size feature for each node in the graph 501, where the neighborhood size feature for a given node specifies the number of other nodes that are connected to the node by a path of length at most N. In this example, N can be a positive integer value. In another example, the feature generation engine 506 can generate an information flow feature for each node in the graph 501. The information flow feature for a given node can specify the fraction of the edges connected to the given node that are outgoing edges, i.e., the fraction of edges connected to the given node that point from the given node to a different node.

In some implementations, the feature generation engine 506 can generate one or more node features that do not directly characterize the topology of the graph relative to the nodes. In one example, the feature generation engine 506 can generate a spatial position feature for each node in the graph 501, where the spatial position feature for a given node specifies the spatial position in the brain of the neuron corresponding to the node, e.g., in a Cartesian coordinate system of the synaptic resolution image of the brain. In another example, the feature generation engine 506 can generate a feature for each node in the graph 501 indicating whether the corresponding neuron is excitatory or inhibitory. In another example, the feature generation engine 506 can generate a feature for each node in the graph 501 that identifies the neuropil region associated with the neuron corresponding to the node.

In some cases, the feature generation engine 506 can use weights associated with the edges in the graph in determining the node features 514. As described above, a weight value for an edge connecting two nodes can be determined, e.g., based on the area of any overlap between tolerance regions around the neurons corresponding to the nodes. In one example, the feature generation engine 506 can determine the node degree feature for a given node as a sum of the weights corresponding to the edges that connect the given node to other nodes in the graph. In another example, the feature generation engine 506 can determine the path length feature for a given node as a sum of the edge weights along the longest path in the graph starting from the node.

The node classification engine 508 can be configured to process the node features 514 to identify a predicted neuron type 510 corresponding to certain nodes of the graph 501. In one example, the node classification engine 508 can process the node features 514 to identify a proper subset of the nodes in the graph 501 with the highest values of the path length feature. For example, the node classification engine 508 can identify the nodes with a path length feature value greater than the 90th percentile (or any other appropriate percentile) of the path length feature values of all the nodes in the graph. The node classification engine 508 can then associate the identified nodes having the highest values of the path length feature with the predicted neuron type of “primary sensory neuron.” In another example, the node classification engine 508 can process the node features 514 to identify a proper subset of the nodes in the graph 501 with the highest values of the information flow feature, i.e., indicating that many of the edges connected to the node are outgoing edges. The node classification engine 508 can then associate the identified nodes having the highest values of the information flow feature with the predicted neuron type of “sensory neuron.” In another example, the node classification engine 508 can process the node features 514 to identify a proper subset of the nodes in the graph 501 with the lowest values of the information flow feature, i.e., indicating that many of the edges connected to the node are incoming edges (i.e., edges that point towards the node). The node classification engine 508 can then associate the identified nodes having the lowest values of the information flow feature with the predicted neuron type of “associative neuron.”

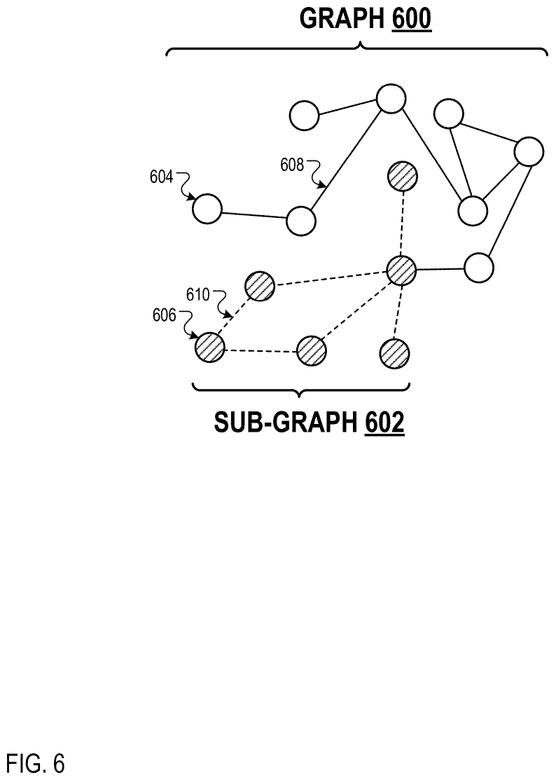

The architecture mapping system 500 can identify a sub-graph 512 of the overall graph 501 based on the predicted neuron types 510 corresponding to the nodes of the graph 501. A “sub-graph” may refer to a graph specified by: (i) a proper subset of the nodes of the graph 501, and (ii) a proper subset of the edges of the graph 501. FIG. 6 provides an illustration of an example sub-graph of an overall graph. In one example, the architecture mapping system 500 can select: (i) each node in the graph 501 corresponding to particular neuron type, and (ii) each edge in the graph 501 that connects nodes in the graph corresponding to the particular neuron type, for inclusion in the sub-graph 512. The neuron type selected for inclusion in the sub-graph can be, e.g., visual neurons, olfactory neurons, memory neurons, or any other appropriate type of neuron. In some cases, the architecture mapping system 500 can select multiple neuron types for inclusion in the sub-graph 512, e.g., both visual neurons and olfactory neurons.

The type of neuron selected for inclusion in the sub-graph 512 can be determined based on the task which the brain emulation neural network 516 will be configured to perform. In one example, the brain emulation neural network 516 can be configured to perform an image processing task, and neurons that are predicted to perform visual functions (i.e., by processing visual data) can be selected for inclusion in the sub-graph 512. In another example, the brain emulation neural network 516 can be configured to perform an odor processing task, and neurons that are predicted to perform odor processing functions (i.e., by processing odor data) can be selected for inclusion in the sub-graph 512. In another example, the brain emulation neural network 516 can be configured to perform an audio processing task, and neurons that are predicted to perform audio processing (i.e., by processing audio data) can be selected for inclusion in the sub-graph 512.

If the edges of the graph 501 are associated with weight values (as described above), then each edge of the sub-graph 512 can be associated with the weight value of the corresponding edge in the graph 501. The sub-graph 512 can be represented, e.g., as a two-dimensional array of numerical values, as described with reference to the graph 501.

Determining the architecture 502 of the brain emulation neural network 516 based on the sub-graph 512 rather than the overall graph 501 can result in the architecture 502 having a reduced complexity, e.g., because the sub-graph 512 has fewer nodes, fewer edges, or both than the graph 501. Reducing the complexity of the architecture 502 can reduce consumption of computational resources (e.g., memory and computing power) by the brain emulation neural network 516, e.g., enabling the brain emulation neural network 516 to be deployed in resource-constrained environments, e.g., mobile devices. Reducing the complexity of the architecture 502 can also facilitate training of the brain emulation neural network 516, e.g., by reducing the amount of training data required to train the brain emulation neural network 516 to achieve an threshold level of performance (e.g., prediction accuracy).

In some cases, the architecture mapping system 500 can further reduce the complexity of the architecture 502 using a nucleus classification engine 518. In particular, the architecture mapping system 500 can process the sub-graph 512 using the nucleus classification engine 518 prior to determining the architecture 502. The nucleus classification engine 518 can be configured to process a representation of the sub-graph 512 as a two-dimensional array of numerical values (as described above) to identify one or more “clusters” in the array.

A cluster in the array representing the sub-graph 512 may refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 518 can identify contiguous regions of the array such that at least a threshold fraction of the components in the region have the value 1. The nucleus classification engine 518 can identify clusters in the array representing the sub-graph 512 by processing the array using a blob detection algorithm, e.g., by convolving the array with a Gaussian kernel and then applying the Laplacian operator to the array. After applying the Laplacian operator, the nucleus classification engine 518 can identify each component of the array having a value that satisfies a predefined threshold as being included in a cluster.

Each of the clusters identified in the array representing the sub-graph 512 can correspond to edges connecting a “nucleus” (i.e., group) of related neurons in brain, e.g., a thalamic nucleus, a vestibular nucleus, a dentate nucleus, or a fastigial nucleus. After the nucleus classification engine 518 identifies the clusters in the array representing the sub-graph 512, the architecture mapping system 500 can select one or more of the clusters for inclusion in the sub-graph 512. The architecture mapping system 500 can select the clusters for inclusion in the sub-graph 512 based on respective features associated with each of the clusters. The features associated with a cluster can include, e.g., the number of edges (i.e., components of the array) in the cluster, the average of the node features corresponding to each node that is connected by an edge in the cluster, or both. In one example, the architecture mapping system 500 can select a predefined number of largest clusters (i.e., that include the greatest number of edges) for inclusion in the sub-graph 512.

The architecture mapping system 500 can reduce the sub-graph 512 by removing any edge in the sub-graph 512 that is not included in one of the selected clusters, and then map the reduced sub-graph 512 to a corresponding neural network architecture, as will be described in more detail below. Reducing the sub-graph 512 by restricting it to include only edges that are included in selected clusters can further reduce the complexity of the architecture 502, thereby reducing computational resource consumption by the brain emulation neural network 516 and facilitating training of the brain emulation neural network 516.

The architecture mapping system 500 can determine the architecture 502 of the brain emulation neural network 516 from the sub-graph 512 in any of a variety of ways. For example, the architecture mapping system 500 can map each node in the sub-graph 512 to a corresponding: (i) artificial neuron, (ii) artificial neural network layer, or (iii) group of artificial neural network layers in the architecture 502, as will be described in more detail next.

In one example, the neural network architecture 502 can include: (i) a respective artificial neuron corresponding to each node in the sub-graph 512, and (ii) a respective connection corresponding to each edge in the sub-graph 512. In this example, the sub-graph 512 can be a directed graph, and an edge that points from a first node to a second node in the sub-graph 512 can specify a connection pointing from a corresponding first artificial neuron to a corresponding second artificial neuron in the architecture 502. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph. An artificial neuron may refer to a component of the architecture 502 that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph 512 can be an undirected graph, and the architecture mapping system 500 can map an edge that connects a first node to a second node in the sub-graph 512 to two connections between a corresponding first artificial neuron and a corresponding second artificial neuron in the architecture. In particular, the architecture mapping system 500 can map the edge to: (i) a first connection pointing from the first artificial neuron to the second artificial neuron, and (ii) a second connection pointing from the second artificial neuron to the first artificial neuron.

In another example, the sub-graph 512 can be an undirected graph, and the architecture mapping system can map an edge that connects a first node to a second node in the sub-graph 512 to one connection between a corresponding first artificial neuron and a corresponding second artificial neuron in the architecture. The architecture mapping system 500 can determine the direction of the connection between the first artificial neuron and the second artificial neuron, e.g., by randomly sampling the direction in accordance with a probability distribution over the set of two possible directions.

In some cases, the edges in the sub-graph 512 is not be associated with weight values, and the weight values corresponding to the connections in the architecture 502 can be determined randomly. For example, the weight value corresponding to each connection in the architecture 502 can be randomly sampled from a predetermined probability distribution, e.g., a standard Normal (N(0,1)) probability distribution.

In another example, the neural network architecture 502 can include: (i) a respective artificial neural network layer corresponding to each node in the sub-graph 512, and (ii) a respective connection corresponding to each edge in the sub-graph 512. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values). In one example, the architecture 502 can include a respective convolutional neural network layer corresponding to each node in the sub-graph 512, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each w_{i (i=}1, . . . , n) is a weight value associated with the connection between the given layer and each of the other layers that provide an input to the given layer (where the weight value for each edge can be specified by the weight value associated with the corresponding edge in the sub-graph), h_{θ}(⋅) represents the operation of applying one or more convolutional kernels to an input to generate a corresponding output, and σ(⋅) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 500 can determine that the neural network architecture includes: (i) a respective group of artificial neural network layers corresponding to each node in the sub-graph 512, and (ii) a respective connection corresponding to each edge in the sub-graph 512. The layers in a group of artificial neural network layers corresponding to a node in the sub-graph 512 can be connected, e.g., as a linear sequence of layers, or in any other appropriate manner.

The neural network architecture 502 can include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network 516. An output artificial neural neuron may refer to an artificial neuron that generates an output which is considered part of the overall output generated by the brain emulation neural network 516. The architecture mapping system 500 can add artificial neurons to the architecture 502 in addition to those specified by nodes in the sub-graph 512 (or the graph 501), and designate the added neurons as input artificial neurons and output artificial neurons. For example, for a brain emulation neural network 516 that is configured to process an input including a 100×100 image to generate an output indicating whether the image is included in each of 1000 categories, the architecture mapping system 500 can add 10,000 (=100×100) input artificial neurons and 1000 output artificial neurons to the architecture. Input and output artificial neurons that are added to the architecture 502 can be connected to the other neurons in the architecture in any of a variety of ways. For example, the input and output artificial neurons can be densely connected to every other neuron in the architecture.

Various operations performed by the described architecture mapping system 500 are optional or can be implemented in a different order. For example, the architecture mapping system 500 can refrain from applying transformation operations to the graph 501 using the transformation engine 504, and refrain from extracting a sub-graph 512 from the graph 501 using the feature generation engine 506, the node classification engine 508, and the nucleus classification engine 518. In this example, the architecture mapping system 500 can directly map the graph 501 to the neural network architecture 502, e.g., by mapping each node in the graph to an artificial neuron and mapping each edge in the graph to a connection in the architecture, as described above.

FIG. 6 illustrates an example graph 600 and an example sub-graph 602. Each node in the graph 600 is represented by a circle (e.g., 604 and 606), and each edge in the graph 600 is represented by a line (e.g., 608 and 610). In this illustration, the graph 600 can be considered a simplified representation of a synaptic connectivity graph (an actual synaptic connectivity graph can have far more nodes and edges than are depicted in FIG. 6). A sub-graph 602 can be identified in the graph 600, where the sub-graph 602 includes a proper subset of the nodes and edges of the graph 600. In this example, the nodes included in the sub-graph 602 are hatched (e.g., 606) and the edges included in sub-graph 602 are dashed (e.g., 610). The nodes included in the sub-graph 602 can correspond to neurons of a particular type, e.g., neurons having a particular function, e.g., olfactory neurons, visual neurons, or memory neurons. The architecture of the brain emulation neural network can be specified by the structure of the entire graph 600, or by the structure of a sub-graph 602, as described above.

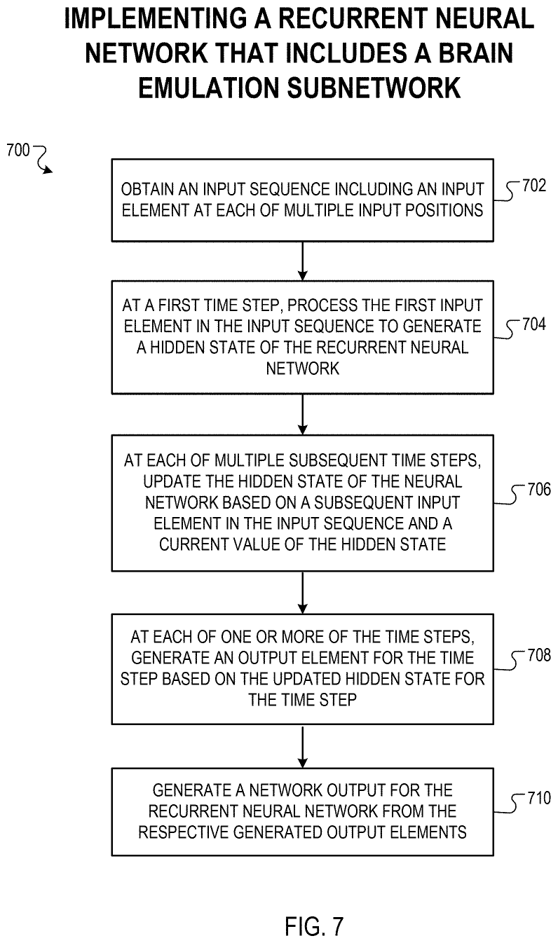

FIG. 7 is a flow diagram of an example process 700 for implementing a recurrent neural network that includes a brain emulation subnetwork. For convenience, the process 700 will be described as being performed by a system of one or more computers located in one or more locations. For example, a system executing a recurrent neural network, e.g., the recurrent neural network 300 of FIG. 3, appropriately programmed in accordance with this specification, can perform the process 700.

The system obtains an input sequence that includes an input element at each of multiple input positions (step 702). The input sequence represents an input to the recurrent neural network. The recurrent neural network includes a brain emulation subnetwork that has a network architecture that has been determined according to a synaptic connectivity graph. The synaptic connectivity graph can represent synaptic connectivity between neurons in a brain of a biological organism.

The recurrent neural network can also include a trained subnetwork. In some implementations, the parameters of the brain emulation subnetwork are untrained while the parameters of the trained subnetwork are trained.

As a particular example, a training system can generate values for the parameters of the trained subnetwork. For example, the training system can determine initial values for the parameters of the trained subnetwork, obtain multiple training examples, and then process the training examples using the recurrent neural network according to (i) the initial values for the parameters of the trained subnetwork and (ii) the values for the parameters of the brain emulation subnetwork (e.g., determined according to the synaptic connectivity graph) in order to update the initial values for the parameters of the trained subnetwork.

The system processes the input sequence using the recurrent neural network to generate a network output. In particular:

At a first time step, the system processes the first input element in the input sequence to generate a hidden state of the recurrent neural network (step 704).

At each of multiple subsequent time steps, the system updates the hidden state of the recurrent neural network based on (i) a subsequent input element in the input sequence corresponding to the subsequent time step and (ii) the current value of the hidden state (step 706).

At each of one or more of the time steps, the system generates an output element for the time step based on the updated hidden state for the time step (step 708). For example, the system can generate a respective output element at each time step.

The hidden state of the recurrent neural network after a particular time step can include, or be generated from, (i) the output element generated at the particular time step, (ii) an intermediate output generated by the recurrent neural network at the particular time step, or iii) both. For example, the intermediate output can be an output of a hidden layer of the recurrent neural network.

The system generates the network output for the recurrent neural network from the respective generated output elements (step 710). In some implementations, the network output is an output sequence that includes each of the generated output elements. In some other implementations, the network output is the final generated output element, i.e., the output element generated at the final time step. In some other implementations, the system processes the respective output elements to generate the network output, e.g., by determining the average of the sum of the output elements.

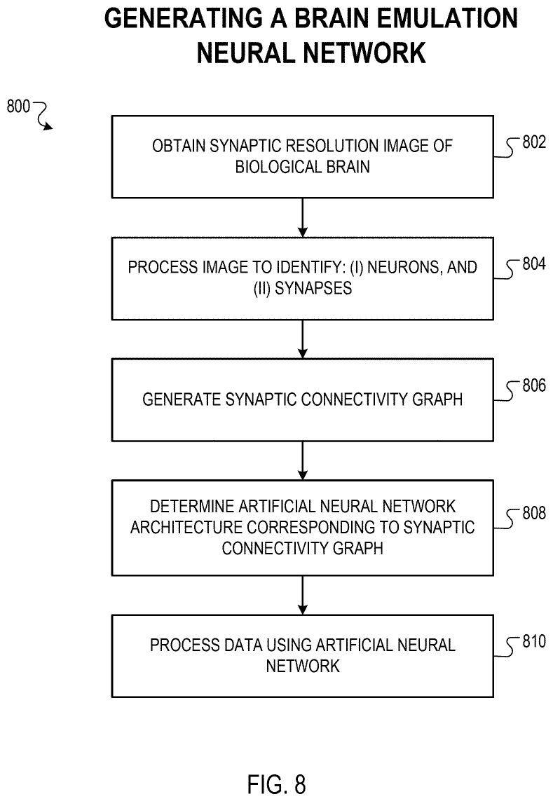

FIG. 8 is a flow diagram of an example process 800 for generating a brain emulation neural network. For convenience, the process 800 will be described as being performed by a system of one or more computers located in one or more locations.

The system obtains a synaptic resolution image of at least a portion of a brain of a biological organism (802).

The system processes the image to identify: (i) neurons in the brain, and (ii) synaptic connections between the neurons in the brain (804).

The system generates data defining a graph representing synaptic connectivity between the neurons in the brain (806). The graph includes a set of nodes and a set of edges, where each edge connects a pair of nodes. The system identifies each neuron in the brain as a respective node in the graph, and each synaptic connection between a pair of neurons in the brain as an edge between a corresponding pair of nodes in the graph.

The system determines an artificial neural network architecture corresponding to the graph representing the synaptic connectivity between the neurons in the brain (808).

The system processes a network input using an artificial neural network having the artificial neural network architecture to generate a network output (810).

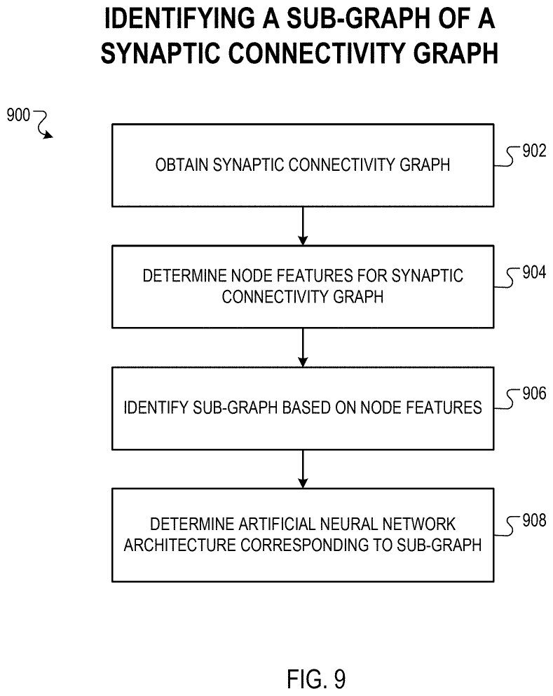

FIG. 9 is a flow diagram of an example process 900 for determining an artificial neural network architecture corresponding to a sub-graph of a synaptic connectivity graph. For convenience, the process 900 will be described as being performed by a system of one or more computers located in one or more locations. For example, an architecture mapping system, e.g., the architecture mapping system 500 of FIG. 5, appropriately programmed in accordance with this specification, can perform the process 900.

The system obtains data defining a graph representing synaptic connectivity between neurons in a brain of a biological organism (902). The graph includes a set of nodes and edges, where each edge connects a pair of nodes. Each node corresponds to a respective neuron in the brain of the biological organism, and each edge connecting a pair of nodes in the graph corresponds to a synaptic connection between a pair of neurons in the brain of the biological organism.

The system determines, for each node in the graph, a respective set of one or more node features characterizing a structure of the graph relative to the node (904).

The system identifies a sub-graph of the graph (906). In particular, the system selects a proper subset of the nodes in the graph for inclusion in the sub-graph based on the node features of the nodes in the graph.

The system determines an artificial neural network architecture corresponding to the sub-graph of the graph (908).

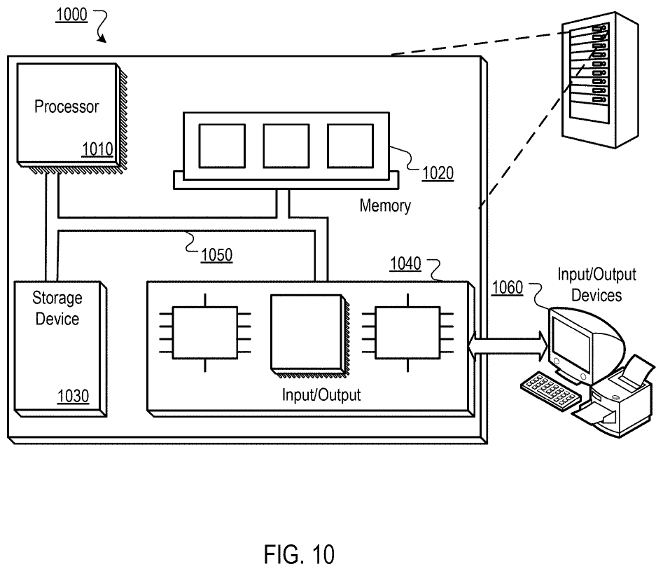

FIG. 10 is a block diagram of an example computer system 1000 that can be used to perform operations described previously. The system 1000 includes a processor 1010, a memory 1020, a storage device 1030, and an input/output device 1040. Each of the components 1010, 1020, 1030, and 1040 can be interconnected, for example, using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 can include, for example, a hard disk device, an optical disk device, a storage device that is shared over a network by multiple computing devices (for example, a cloud storage device), or some other large capacity storage device.

The input/output device 1040 provides input/output operations for the system 1000. In one implementation, the input/output device 1040 can include one or more network interface devices, for example, an Ethernet card, a serial communication device, for example, and RS-232 port, and/or a wireless interface device, for example, and 802.11 card. In another implementation, the input/output device 1040 can include driver devices configured to receive input data and send output data to other input/output devices, for example, keyboard, printer and display devices 1060. Other implementations, however, can also be used, such as mobile computing devices, mobile communication devices, and set-top box television client devices.

Although an example processing system has been described in FIG. 10, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining an input sequence comprising an input element at each of a plurality of input positions; and

processing the input sequence using a recurrent neural network to generate a network output, wherein the recurrent neural network comprises a brain emulation subnetwork having a network architecture that has been determined according to a synaptic connectivity graph, wherein the synaptic connectivity graph represents synaptic connectivity between neurons in a brain of a biological organism, the processing comprising:
at a first time step, processing a first input element in the input sequence to generate a hidden state of the recurrent neural network;
at each of a plurality of subsequent time steps, updating the hidden state of the recurrent neural network based on i) a subsequent input element in the input sequence and ii) a current value of the hidden state; and
at each of one or more of the plurality of time steps, generating an output element for the time step based on the updated hidden state for the time step.

Embodiment 2 is the method of embodiment 1, wherein:

the network output comprises an output sequence,

the output sequence comprises a respective output element at each of a plurality of output positions, and

the hidden state of the recurrent neural network after a particular time step comprises i) the output element generated at the particular time step, ii) an intermediate output generated by the recurrent neural network at the particular time step, or iii) both.

Embodiment 3 is the method of embodiment 2, wherein the intermediate output is an output of a hidden layer of the recurrent neural network.

Embodiment 4 is the method of any one of embodiments 1-3, wherein:

the brain emulation subnetwork of the recurrent neural network comprises a plurality of untrained first network parameters; and

the recurrent neural network further comprises a trained subnetwork comprising a plurality of trained second network parameters.

Embodiment 5 is the method of embodiment 4, wherein updating the hidden state of the recurrent neural network comprises:

processing the subsequent input element in the input sequence using the trained subnetwork to generate a trained subnetwork output;

processing the trained subnetwork output using the brain emulation subnetwork to generate a brain emulation subnetwork output; and

combining the brain emulation subnetwork output with the current value of the hidden state to generate an updated value of the hidden state.

Embodiment 6 is the method of embodiment 5, wherein combining the brain emulation subnetwork output with the current value of the hidden state comprises:

processing the current value of the hidden state using a second brain emulation subnetwork of the recurrent neural network to generate a second brain emulation subnetwork output, wherein the second brain emulation subnetwork has a second network architecture that has been determined according to the synaptic connectivity graph; and

combining the brain emulation subnetwork output and the second brain emulation subnetwork output to generate the updated value of the hidden state.

Embodiment 7 is the method of embodiment 6, wherein the second network architecture of the second brain emulation subnetwork is the same as the network architecture of the brain emulation subnetwork.

Embodiment 8 is the method of any one of embodiments 4-7, wherein determining the network architecture of the recurrent neural network comprises generating values for the plurality of first network parameters and the plurality of second network parameters, comprising:

determining initial values for the plurality of first network parameters;

generating values for the second plurality of network parameters using the synaptic connectivity graph;

obtaining a plurality of training examples; and

processing the plurality of training examples using the recurrent neural network according to i) the initial values for the plurality of first network parameters and ii) the values for the second plurality of network parameters to update the initial values for the plurality of first network parameters.

Embodiment 9 is the method of any one of embodiments 1-8, wherein the input sequence represents audio data.

Embodiment 10 is the method of embodiment 9, wherein the network output characterizes a likelihood that the audio data is a verbalization of a predefined word or phrase.

Embodiment 11 is the method of any one of embodiments 9 or 10, wherein each input element comprises one or more of:

an audio sample,

a mel spectrogram generated from the audio data, or

a mel-frequency cepstral coefficient (MFCC) representation of the audio data.

Embodiment 12 is the method of any one of embodiments 9-11, wherein the synaptic connectivity graph representing synaptic connectivity between neurons in the brain of the biological organism corresponds to an auditory region of the brain of the biological organism.

Embodiment 13 is the method of any one of embodiments 1-12, further comprising generating the network output for the recurrent neural network from the output elements generated at one or more respective time steps.

Embodiment 14 is the method of any one of embodiments 1- 13, wherein:

the synaptic connectivity graph comprises a plurality of nodes and edges, wherein each edge connects a pair of nodes; and

the synaptic connectivity graph was generated by:
determining a plurality of neurons in the brain of the biological organism and a plurality of synaptic connections between pairs of neurons in the brain of the biological organism;
mapping each neuron in the brain of the biological organism to a respective node in the synaptic connectivity graph; and
mapping each synaptic connection between a pair of neurons in the brain to an edge between a corresponding pair of nodes in the synaptic connectivity graph.

Embodiment 15 is the method of embodiment 14, wherein determining the plurality of neurons and the plurality of synaptic connections comprises:

obtaining a synaptic resolution image of at least a portion of the brain of the biological organism; and

processing the image to identify the plurality of neurons and the plurality of synaptic connections.

Embodiment 16 is the method of embodiment 15, wherein determining the network architecture of the recurrent neural network comprises:

mapping each node in the synaptic connectivity graph to a corresponding artificial neuron in the network architecture; and

for each edge in the synaptic connectivity graph:
mapping the edge to a connection between a pair of artificial neurons in the network architecture that correspond to the pair of nodes in the synaptic connectivity graph that are connected by the edge.

Embodiment 17 is the method of embodiment 16, wherein:

determining the network architecture of the recurrent neural network further comprises processing the image to identify a respective direction of each of the synaptic connections between pairs of neurons in the brain;

generating the synaptic connectivity graph further comprises determining a direction of each edge in the synaptic connectivity graph based on the direction of the synaptic connection corresponding to the edge; and

each connection between a pair of artificial neurons in the network architecture has a direction specified by the direction of the corresponding edge in the synaptic connectivity graph.

Embodiment 18 is the method of any one of embodiment 16 or 17, wherein:

determining the network architecture of the recurrent neural network further comprises processing the image to determine a respective weight value for each of the synaptic connections between pairs of neurons in the brain;

generating the synaptic connectivity graph further comprises determining a weight value for each edge in the synaptic connectivity graph based on the weight value for the synaptic connection corresponding to the edge; and

each connection between a pair of artificial neurons in the network architecture has a weight value specified by the weight value of the corresponding edge in the synaptic connectivity graph.

Embodiment 19 is a system comprising: one or more computers and one or more storage devices storing instructions that are operable, when executed by the one or more computers, to cause the one or more computers to perform the method of any one of embodiments 1 to 18.

Embodiment 20 is one or more non-transitory computer storage media encoded with a computer program, the program comprising instructions that are operable, when executed by data processing apparatus, to cause the data processing apparatus to perform the method of any one of embodiments 1 to 18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method comprising:
obtaining an input sequence comprising an input element at each of a plurality of input positions; and
processing the input sequence using a recurrent neural network to generate a network output, wherein the recurrent neural network comprises a brain emulation subnetwork having a network architecture that has been determined according to a synaptic connectivity graph, wherein the synaptic connectivity graph represents synaptic connectivity between neurons in a brain of a biological organism, the processing comprising:
at a first time step, processing a first input element in the input sequence to generate a hidden state of the recurrent neural network;
at each of a plurality of subsequent time steps, updating the hidden state of the recurrent neural network based on i) a subsequent input element in the input sequence and ii) a current value of the hidden state; and
at each of one or more of the plurality of time steps, generating an output element for the time step based on the updated hidden state for the time step.

2. The method of claim 1, wherein:
the network output comprises an output sequence,
the output sequence comprises a respective output element at each of a plurality of output positions, and
the hidden state of the recurrent neural network after a particular time step comprises i) the output element generated at the particular time step, ii) an intermediate output generated by the recurrent neural network at the particular time step, or iii) both.

3. The method of claim 2, wherein the intermediate output is an output of a hidden layer of the recurrent neural network.

4. The method of claim 1, wherein:
the brain emulation subnetwork of the recurrent neural network comprises a plurality of untrained first network parameters; and
the recurrent neural network further comprises a trained subnetwork comprising a plurality of trained second network parameters.

5. The method of claim 4, wherein updating the hidden state of the recurrent neural network comprises:
processing the subsequent input element in the input sequence using the trained subnetwork to generate a trained subnetwork output;
processing the trained subnetwork output using the brain emulation subnetwork to generate a brain emulation subnetwork output; and
combining the brain emulation subnetwork output with the current value of the hidden state to generate an updated value of the hidden state.

6. The method of claim 5, wherein combining the brain emulation subnetwork output with the current value of the hidden state comprises:
processing the current value of the hidden state using a second brain emulation subnetwork of the recurrent neural network to generate a second brain emulation subnetwork output, wherein the second brain emulation subnetwork has a second network architecture that has been determined according to the synaptic connectivity graph; and
combining the brain emulation subnetwork output and the second brain emulation subnetwork output to generate the updated value of the hidden state.

7. The method of claim 6, wherein the second network architecture of the second brain emulation subnetwork is the same as the network architecture of the brain emulation subnetwork.

8. The method of claim 4, wherein determining the network architecture of the recurrent neural network comprises generating values for the plurality of first network parameters and the plurality of second network parameters, comprising:
determining initial values for the plurality of first network parameters;
generating values for the second plurality of network parameters using the synaptic connectivity graph;
obtaining a plurality of training examples; and
processing the plurality of training examples using the recurrent neural network according to i) the initial values for the plurality of first network parameters and ii) the values for the second plurality of network parameters to update the initial values for the plurality of first network parameters.

9. The method of claim 1, wherein the input sequence represents audio data.

10. The method of claim 9, wherein the network output characterizes a likelihood that the audio data is a verbalization of a predefined word or phrase.

11. The method of claim 9, wherein each input element comprises one or more of:
an audio sample,
a mel spectrogram generated from the audio data, or
a mel-frequency cepstral coefficient (MF CC) representation of the audio data.

12. The method of claim 9, wherein the synaptic connectivity graph representing synaptic connectivity between neurons in the brain of the biological organism corresponds to an auditory region of the brain of the biological organism.

13. The method of claim 1, further comprising generating the network output for the recurrent neural network from the output elements generated at one or more respective time steps.

14. The method of claim 1, wherein:
the synaptic connectivity graph comprises a plurality of nodes and edges, wherein each edge connects a pair of nodes; and
the synaptic connectivity graph was generated by:
determining a plurality of neurons in the brain of the biological organism and a plurality of synaptic connections between pairs of neurons in the brain of the biological organism;
mapping each neuron in the brain of the biological organism to a respective node in the synaptic connectivity graph; and
mapping each synaptic connection between a pair of neurons in the brain to an edge between a corresponding pair of nodes in the synaptic connectivity graph.

15. The method of claim 14, wherein determining the plurality of neurons and the plurality of synaptic connections comprises:
obtaining a synaptic resolution image of at least a portion of the brain of the biological organism; and
processing the image to identify the plurality of neurons and the plurality of synaptic connections.

16. The method of claim 15, wherein determining the network architecture of the recurrent neural network comprises:
mapping each node in the synaptic connectivity graph to a corresponding artificial neuron in the network architecture; and
for each edge in the synaptic connectivity graph:
mapping the edge to a connection between a pair of artificial neurons in the network architecture that correspond to the pair of nodes in the synaptic connectivity graph that are connected by the edge.

17. The method of claim 16, wherein:
determining the network architecture of the recurrent neural network further comprises processing the image to identify a respective direction of each of the synaptic connections between pairs of neurons in the brain;
generating the synaptic connectivity graph further comprises determining a direction of each edge in the synaptic connectivity graph based on the direction of the synaptic connection corresponding to the edge; and
each connection between a pair of artificial neurons in the network architecture has a direction specified by the direction of the corresponding edge in the synaptic connectivity graph.

18. The method of claim 16, wherein:
determining the network architecture of the recurrent neural network further comprises processing the image to determine a respective weight value for each of the synaptic connections between pairs of neurons in the brain;
generating the synaptic connectivity graph further comprises determining a weight value for each edge in the synaptic connectivity graph based on the weight value for the synaptic connection corresponding to the edge; and
each connection between a pair of artificial neurons in the network architecture has a weight value specified by the weight value of the corresponding edge in the synaptic connectivity graph.

19. A system comprising one or more computers and one or more storage devices storing instructions that are operable, when executed by the one or more computers, to cause the one or more computers to perform operations comprising:
obtaining an input sequence comprising an input element at each of a plurality of input positions; and
processing the input sequence using a recurrent neural network to generate a network output, wherein the recurrent neural network comprises a brain emulation subnetwork having a network architecture that has been determined according to a synaptic connectivity graph, wherein the synaptic connectivity graph represents synaptic connectivity between neurons in a brain of a biological organism, the processing comprising:
at a first time step, processing a first input element in the input sequence to generate a hidden state of the recurrent neural network;
at each of a plurality of subsequent time steps, updating the hidden state of the recurrent neural network based on i) a subsequent input element in the input sequence and ii) a current value of the hidden state; and
at each of one or more of the plurality of time steps, generating an output element for the time step based on the updated hidden state for the time step.

20. One or more non-transitory storage media storing instructions that when executed by one or more computers cause the one or more computers to perform operations comprising:
obtaining an input sequence comprising an input element at each of a plurality of input positions; and
processing the input sequence using a recurrent neural network to generate a network output, wherein the recurrent neural network comprises a brain emulation subnetwork having a network architecture that has been determined according to a synaptic connectivity graph, wherein the synaptic connectivity graph represents synaptic connectivity between neurons in a brain of a biological organism, the processing comprising:
at a first time step, processing a first input element in the input sequence to generate a hidden state of the recurrent neural network;
at each of a plurality of subsequent time steps, updating the hidden state of the recurrent neural network based on i) a subsequent input element in the input sequence and ii) a current value of the hidden state; and
at each of one or more of the plurality of time steps, generating an output element for the time step based on the updated hidden state for the time step.
